(19) United States
(12) Patent Application Publication
(10) Pub. No.: US 2010/0107222 A1
(43) Pub. Date: Apr. 29, 2010

(54) METHOD AND APPARATUS FOR IMPLEMENTING SECURE AND ADAPTIVE PROXIES

(76) Inventor: Avery Glasser, Madrid (ES)

Correspondence Address: Brian R. Galvin, P.O. BOX 2360, SILVERDALE, WA, 98383-2360, US

(21) Appl. No.: 12/450,134

(22) PCT Filed: Mar. 2, 2007
(86) PCT No.: PCT/US07/63221

§ 371 Date: Sep. 10, 2009

Related U.S. Application Data
(60) Provisional application No. 60/778,266, filed on Mar. 2, 2006.

(51) Int. Cl. H04L 9/00

(52) U.S. Cl. 726/3

(57) ABSTRACT

Methods and apparatus for implementing common authentication and security policies across applications served over a data transmission network, such as the internet, http or https, are disclosed. The common authentication and security policies are implemented without mandating specific changes to be applied to the applications themselves. An authentication process can be dynamically performed based on different needed security levels. Applications can be graphical (e.g., web) or voice in nature and can use any applicable and available security method.

### FIELD OF THE DISCLOSURE

The present disclosure relates generally to user registration and authentication on web and web-like infrastructures, and more specifically, to methods and apparatus for implementing common authentication and security policies that support different application types.

### BACKGROUND OF THE DISCLOSURE

FIG. 1 is a diagram showing the standard session components of an XML-based voice or web transaction. The standard session components include a computer with a Web browser, a VoiceXML browser, which is coupled to a telephone via a public switched telephone network (PSTN), an application server, and an application data store. Requests for applications or data originate from either computer with the Web browser or the VoiceXML browser. In the former instance, a requested application or data is sent from the application server in accordance with a certain communication protocol, e.g., http or https, to the computer with the Web browser. A display coupled to the computer with the Web browser then displays a graphics relating to the accessed application or data. Alternatively, the VoiceXML browser interprets VoiceXML scripts to present spoken information to a user. The VoiceXML browser thereby provides a speech interface, which may be viewed as a voice equivalent of the graphical interface used by the Web browser. In addition to the standard session components in FIG. 1, the session components may include a single proprietary security engine coupled to the application server, as shown in FIG. 2.

Due to both internal requirements as well as government and industry mandates, enterprises often must restrict access to sensitive applications, data and environments to authorized users. For example, the healthcare industry has implemented the Health Insurance Portability and Accountability Act (HIPAA) under government mandate. This act requires that all covered entities (e.g. doctors, hospitals, insurance agencies) restrict the access and transmission of “protected health information” to only authorized personnel. As “protected health information” may need to be accessed by a doctor over the phone or web depending on the situation, having a single system that can apply common rules across both access modalities is critical. Unfortunately, prior art approaches to implementing common security methods across multiple modalities require significant re-engineering of applications in order to directly interface with the security and authentication methods.

What is needed is methods and apparatus for providing common security policies and authentication practices across multiple environments and for multiple access modalities without requiring that specific changes be made to the application themselves.

### SUMMARY OF THE DISCLOSURE

Methods and apparatus for implementing common authentication and security policies across applications served over a data transmission network, such as the internet, http or https, are disclosed. The common authentication and security policies are implemented without mandating specific changes to be applied to the applications themselves. Applications can be graphical (e.g., web) or voice in nature and can use any applicable and available security method.

According to an aspect of the disclosure, exemplary systems for applying common authentication and security policies to various application types (e.g. graphical, voice, etc.) are disclosed. An exemplary system includes an authentication proxy interposed between a user device, such as a web browser of a computer or a VoiceXML browser for telephones, and an application server. Through the authentication proxy, the application server employs authentication and security policies that are common to a plurality of different application types. The authentication proxy can be implemented locally at an enterprise or may be implemented as a shared resource across multiple enterprises.

According to an aspect of the disclosure, a system applying common authentication and security policies to various application types (e.g. graphical, voice, etc.) comprises an authentication proxy in communication with a security rendering proxy. According to this aspect of the disclosure the security rendering proxy provides a common interface between the authentication proxy (or other XML-compatible proxy or browser) and a core security engine (e.g., a smartcard authenticator, biometric engine, token ID system, password management system, etc.) Once a user is authenticated, the security rendering proxy renders a markup language message and passes it on to the browser of a user device (e.g. computer web browser or VoiceXML browser).

According to an aspect of the disclosure, a method of authenticating and securing a communication between a client and a server includes: receiving an https request from a user device at an http server; (ii) redirecting the https request to an authentication proxy; (iii) consulting an authentication policy database to determine a security level of a service corresponding to the https request; (iv) determining whether an authentication method associated with the user device has a minimum acceptable security level rating; communicating authentication data collected from the authentication method to a third-party authentication service; and (v) opening a connection between the http server and the user device if the authentication data authenticates the user and the security level of the authentication method is equal to or greater than the security level of the service corresponding to the https request.

In one embodiment, an exemplary method for authenticating and securing a communication between a user device and an application server. The method including receiving information related to a service request initiated by the user device, wherein the service request relates to access a service provided by an application of the application server; determining a needed security level corresponding to the received service request based on authentication policy data, wherein the authentication policy data specifies a needed security level corresponding to each of a plurality of service requests for each of multiple applications; determining whether a security level rating of an authentication method associated with the user device satisfies the needed security level corresponding to the received service request; responsive to the security level rating of the authentication method associated with the user device failing to satisfy the needed security level corresponding to the service request, identifying an authentication process appropriate to the user device; collecting authentication data from the user device according to the identified authentication process; performing the identified authentication process; and based on a result of the performed authentication process, selectively allowing the user device to access a service corresponding to the service request. For instance, the multiple applications may be an application provided for accessing data provided by a bank, a medical data center, a doctor's office, an on-line shopping site, a human resource database, etc.

In one aspect, a connection between the application server and the user device is opened if the result of the identified authentication process authenticates the user. In another aspect, if the result of the identified authentication process authenticates the user, the authentication system forwards data received from the application providing the requested service. In other words, the application server does not establish direct connections with the user device during transmission of requested data or service. According to one embodiment, the exemplary method, responsive to the security level rating of the authentication method associated with the user device satisfying the needed security level corresponding to the service request, allows the user device to access the service corresponding to the service request. In one embodiment, the security level rating of the authentication method associated with the user device is determined to have satisfied the needed security level corresponding to the service request, if the security level rating of the authentication method is equal to or greater than the needed security level. The multiple applications may reside on different servers. Different service requests for services provided by different applications may have the same or different needed security levels.

According to one embodiment, the authentication process appropriate to the user device is identified by performing the steps of: accessing information related to one or more available authentication processes satisfying the needed security level; and from the one or more available authentication processes satisfying the needed security level, selecting one of the one or more authentication process as the authentication process appropriate to the user device.

An exemplary data processing system for authenticating and securing a communication between a user device and an application server according to this disclosure comprising: a data processor for processing data; and a data storage device for storing instructions which, upon execution by the data processor, control the data processing system performs the steps of receiving information related to a service request initiated by the user device, wherein the service request relates to access a service provided by an application of the application server; determining a needed security level corresponding to the received service request based on authentication policy data, wherein the authentication policy data specifies a needed security level corresponding to each of a plurality of service requests for each of multiple applications; determining whether a security level rating of an authentication method associated with the user device satisfies the needed security level corresponding to the received service request; responsive to the security level rating of the authentication method associated with the user device failing to satisfy the needed security level corresponding to the service request, identifying an authentication process appropriate to the user device; collecting authentication data from the user device according to the identified authentication process; performing the identified authentication process; and based on a result of the performed authentication process, selectively allowing the user device to access a service corresponding to the service request. A connection between the application server and the user device may be opened if the result of the identified authentication process authenticates the user. A data processing system may be implemented by a computer or any type of machines capable of processing data.

In one embodiment, the instructions, upon execution by the data processor, further control the data processing system to perform the step of responsive to the security level rating of the authentication method associated with the user device satisfying the needed security level corresponding to the service request, allowing the user device to access the service corresponding to the service request. The security level rating of the authentication method associated with the user device is determined to have satisfied the needed security level corresponding to the service request, if the security level rating of the authentication method is equal to or greater than the needed security level. The multiple applications may reside on different servers, and different service requests may have different needed security levels. The authentication process appropriate to the user device is identified by performing the steps of accessing information related to one or more available authentication processes satisfying the needed security level; and from the one or more available authentication processes satisfying the needed security level, selecting one of the one or more authentication process as the authentication process appropriate to the user device. The exemplary system may be implemented as a proxy server handling traffic for the application server.

According to another embodiment of this disclosure, an exemplary system for authenticating and securing a communication between a user device and an application server comprising: means for receiving information related to a service request initiated by the user device, wherein the service request relates to access a service provided by an application of the application server; means for determining a needed security level corresponding to the received service request based on authentication policy data, wherein the authentication policy data specifies a needed security level corresponding to each of a plurality of service requests for each of multiple applications; means for determining whether a security level rating of an authentication method associated with the user device satisfies the needed security level corresponding to the received service request; means for identifying an authentication process appropriate to the user device, in response to the security level rating of the authentication method associated with the user device failing to satisfy the needed security level corresponding to the service request; means for collecting authentication data from the user device according to the identified authentication process; means for performing the identified authentication process; and means for selectively allowing the user device to access a service corresponding to the service based on a result of the performed authentication process.

Other features and advantages of the present disclosure will be understood upon reading and understanding the detailed description of the preferred exemplary embodiments, in conjunction with reference to the drawings, a brief description of which are provided below.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 is a diagram showing standard session components of an XML-based voice or web transaction;

FIG. 2 is a diagram showing standard session components of an XML-based voice or web transaction n, and a single proprietary security engine coupled to an application server of the session components;

FIG. 3 is a block diagram of showing an exemplary authentication system according to an embodiment of the present disclosure;

FIG. 4 is an expanded view of FIG. 3;

FIG. 5 is an architectural diagram of an exemplary GSRP, which may be used to implement the GSRP in the session component diagrams in FIGS. 3 and 4; and

FIG. 6 is a flowchart illustrating exemplary GSRP rules, according to an aspect of the present disclosure.

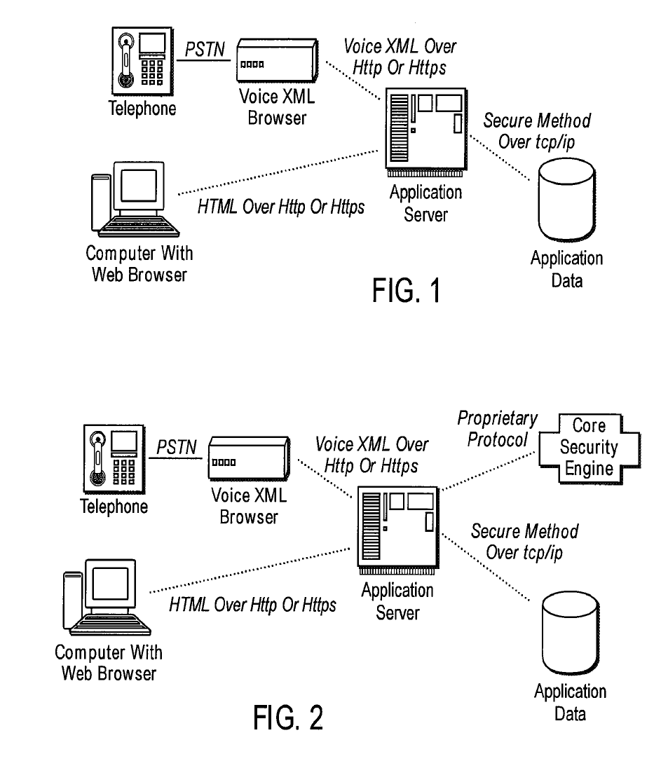

### DETAILED DESCRIPTION OF ILLUSTRATIVE EMBODIMENTS

Those of ordinary skill in the art will realize that the following detailed description of the present disclosure is illustrative only and is not intended to be in any way limiting. Other embodiments of the present disclosure will readily suggest themselves to such skilled persons having the benefit of this disclosure. Reference will now be made in detail to implementations of the present disclosure as illustrated in the accompanying drawings. The same reference indicators will be used throughout the drawings and the following detailed description to refer to the same or like parts.

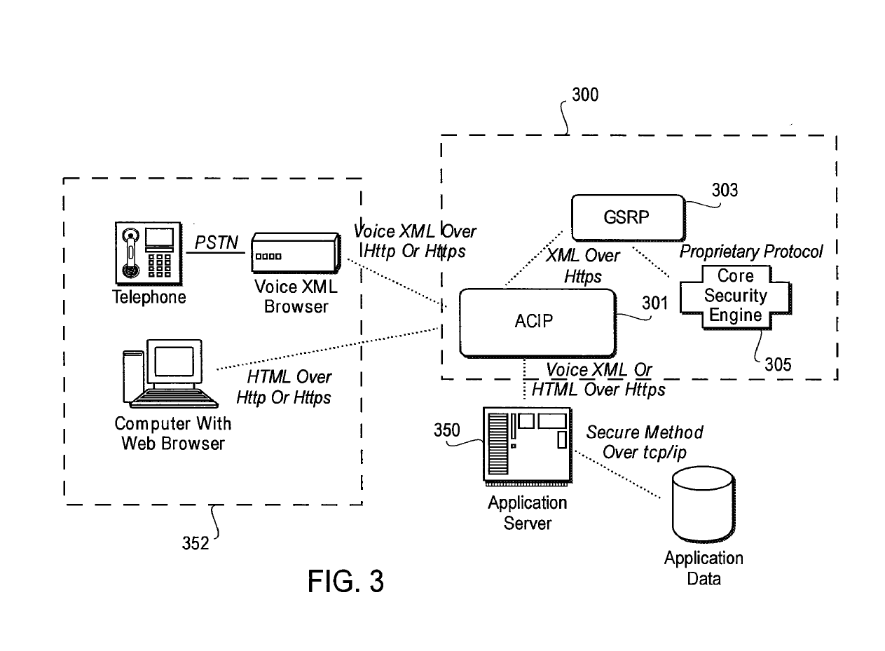

FIG. 3 shows an exemplary authentication system 300 according to an embodiment of this disclosure. The authentication system 300 includes a Generic Security Rendering Proxy (GSRP) 303, a core security engine 305 and an Authenticating Common Interface Proxy (ACIP) 301, which sits between a user device 352 and an application server 350, communicating via a transmission protocol such as http or https. A user utilizes the user device 352 to access an application and/or a service provided by application server 350. The user device 352 may be implemented as an XML browser (e.g., a VoiceXML browser, HTML browser, XHTML browser) or any type of device that can form communications with the authentication system 300 and/or application server 350. The ACIP 301 can be implemented locally by an enterprise, or as a shared resource across multiple enterprises by a service provider. The core security engine 305 is a system for performing authentication based on one or more prescribed means, such as a smartcard authenticator, biometric engine, token ID system or password management system. The GSRP 303 provides a common interface between the ACIP 301 or other XML-compatible proxy or browser and the core security engine 305.

The user may send one or more requests for an application, which will be redirected through the ACIP 301. The ACIP 301 then applies security policies, definable per application, enterprise or as a global requirement and acts as an auditable external authentication device. When a request for enrollment of a new user or authentication of an existing user is passed, the GSRP 303 selects the appropriate user dialog (graphical/text for the web, audible for the telephone), renders the appropriate markup language, and passes it along to the user device 352, such as a XML browser. In one embodiment, the authentication system 300 includes multiple core security engines.

According to one embodiment, communication between the ACIP 301, the GSRP 303 and the Application Server 350 are via encrypted protocols. Communication between the GSRP 303 and the core security engine 305 are via proprietary core security engine protocols.

When a user initiates a request via a user device 352 for a specific service provided by an application residing on the application server 350, the authentication system 300 determines a needed security level corresponding to the received service request based on authentication policy data. The authentication policy data can be stored in a local or remote database and specifies a needed security level corresponding to each of a plurality of service requests for each of multiple applications. The authentication system 300 may dynamically access the authentication policy data stored in a remote site via a data transmission network.

The authentication system 300 determines whether a security level rating of an authentication method associated with the user device 352 satisfies the needed security level corresponding to the received service request. For instance, upon an initial log in process, the user device 352 may have been authenticated by using a combination of a registered user name and passwords, which may have a lower security level than a fingerprint biometric authentication, which may be needed by a different type of service, such as accessing a confidential database or transferring money from a bank account.

Responsive to the security level rating of the authentication method associated with the user device 352 failing to satisfy the needed security level corresponding to the service request, the authentication system 300 identifies an authentication process appropriate to the user device 352, and collects authentication data from the user device 352 according to the identified authentication process. Then, the authentication system 300 performs the identified authentication process. Based on a result of the performed authentication process, the authentication system 300 selectively allows the user device 352 to access a service corresponding to the service request.

The operation of the authentication system 300 is further illustrated in detail in the following example. For the purpose of the illustration, the XML service to be secured is a HTML (web) interaction with a banking service operating on the application server 350, such as an http server operating at https://www.bank.com/index.html. The authentication system 300 operates as a proxy server located at https://www.proxy.com and operates an authentication service for www.bank.com at https://www.proxy.com/bank/.

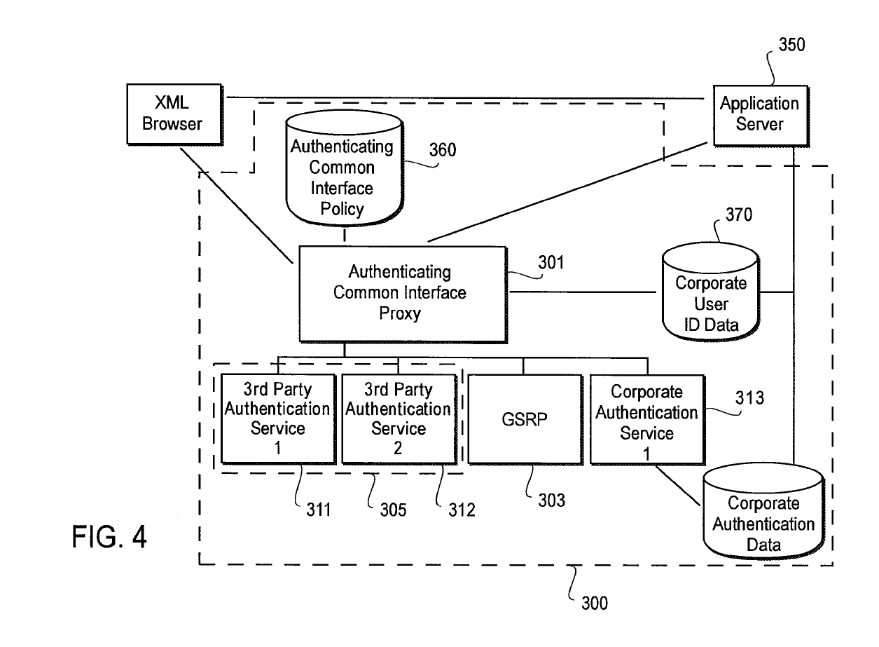

As shown in more details in FIG. 4, the authentication system 300 has access to 3^{rd} Party Authentication Service 1, which is a smartcard identification service with a security level of 3, and 3^{rd} Party Authentication Service 2, which is a voice biometric service with a security level of 4. A Corporate Authentication Service 1, which is a bank supplied service that uses 6 character passwords with a security level of 1, is also accessible by the authentication system 300.

A user enters the URI (uniform resource identifier) https://www.bank.com/index.html into the web browser (XML Browser) of the user device 352. The web browser, using the secure-http (https) protocol, contacts the Application Server 350. The Application Server 350 determines that this application needs to be secured and using an available redirection method (e.g., a META Redirect, opening a new window or pane in a frameset), redirecting the http request to the authentication system 300 at URI https://www.proxy.com/bank/index.html. The authentication system 300 consults authentication policy data stored in an Authenticating Common Interface Policy Database 360, to determine which webpage to open and what the minimum security level is for the bank XML service. For instance, for a user's request for bank balance lookups, the authentication policy data corresponding to the bank may specify that a security level of 2 is required.

The webpage that is opened is branded based on the bank's design and requests a user's claimed ID (also known as a login). The ACIP 301 collects the data submitted by the user, and via a secure method, sends the claimed ID to the Corporate User ID Data Base 370 and receives back which third party authentication services the user has available to them, as well as which are applicable based on the transaction type that is being employed by the user. For example, a fingerprint biometric or smartcard is not applicable to or appropriate for a telephone based transaction. In this example, the user has registrations on all three Corporate and 3^{rd} Party Authentication Services. Because the service of bank balance lookups requires a security level of 2, the Corporate Authentication Service 1 is not applicable for the purpose of further authenticating the user device 352, and is therefore ignored.

The ACIP 301 then checks the Authenticating Common Interface Policy Database 360 for the required pre-requisites for the applicable 3^{rd} Party Authentication Services, which for service 1 is a smartcard reader and for service 2 is telephone access. The authentication system 300 presents the user with a webpage that asks which method of authentication is preferred for this transaction. The user may select smartcard and confirms that the smartcard reader is installed and active. The user inserts the smartcard and the authentication data is securely transmitted to the ACIP 301 and through to the 3^{rd} Party Authentication Service 1. After processing the authentication data sent by the user, the 3^{rd} Party Authentication Service 1 confirms that the smartcard has been passed and the ACIP 301 assigns this transaction session a security level of 3. The ACIP 301 then opens a connection to the Application Server 350 and allows the balance lookup service to proceed. In one embodiment, the ACIP 301, uses a method such as an https GET or PUT, to indicate that the security level is 3.

At a point in the transaction, the user may decide to request an international wire transfer, which quires a higher security level of 4. The Application Server 350 now determines that the security level of the transaction requested is too low, and queries the ACIP 301 (via an https PUT or GET) to determine if the user has a method which is rated at a security level of 4 or higher available. The ACIP 301 queries the Corporate User ID Data Base 370 and the Authenticating Common Interface Policy Data Base 360, and confirms that the voice biometric 3^{rd} Party Authentication Service 2 meets the needed security level. The ACIP 301 then serves a webpage that states for the requested transaction, another security method is required. The user is then given instructions, provided by the 3^{rd} Party Authentication Service 2 regarding how to perform a voice biometric authentication (For example, call a phone number and follow the instructions). The user performs the needed steps specified in the instructions. Authentication data generated by the steps is collected and sent to the 3^{rd} Party Authentication Service 2 for authentication. The 3^{rd} Party Authentication Service 2 communicates back to the ACIP 301 via a secure method that the user is authenticated and the security level of the session is increased to 4. The ACIP 301 then resumes the connection to the Application Server 350 and allows the wire transfer service to proceed. The ACIP 301, using a method such as an https GET or PUT communicates that the security level is 4.

Since https is an encrypted protocol and the ACIP 301 and Application Server 350 will have to use strong SSL certificates to ensure that the endpoints are who they claim to be, this method is inherently following the security methods proscribed by the W3C.

As this works on all XML based services, it can be used for securing voice communications via telephone or computer microphone, web, WAP and other methods. Additionally, the ACIP can use private 3^{rd} party authentication services, corporate supplied authentication services (internal PINs and passwords) or even public authentication services (such as Yahoo! BBAuth or Microsoft Passport).

GSRP Detailed Description

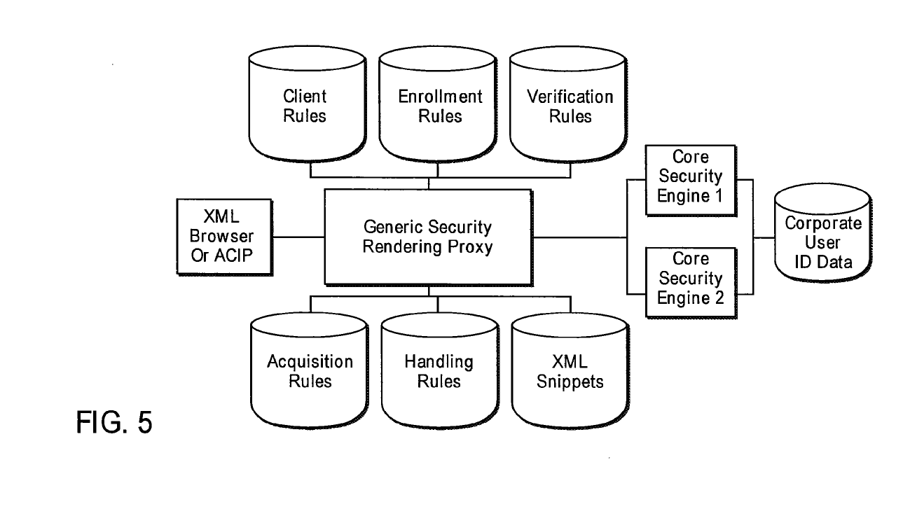

FIG. 5 further illustrates the operation of GSRP. As shown in FIG. 5, an XML Browser (for example a VoiceXML browser for voice transactions, a web browser for web transactions, or an ACIP) sends a https request to the Generic Security Rendering Proxy (GSRP), submitting data using an available method such as http PUT or GET such as:

applicationID (example: “Bank.com_application_{—}1”)

Platform (example: “VoiceXML” or “HTML”)

Engine (example: “Voice1”, “Password”, “Fingerprint”) and optional data such as

Transaction Type (Enrollment or Authentication)

userID (example: “13295OPS” or “John Smith”)

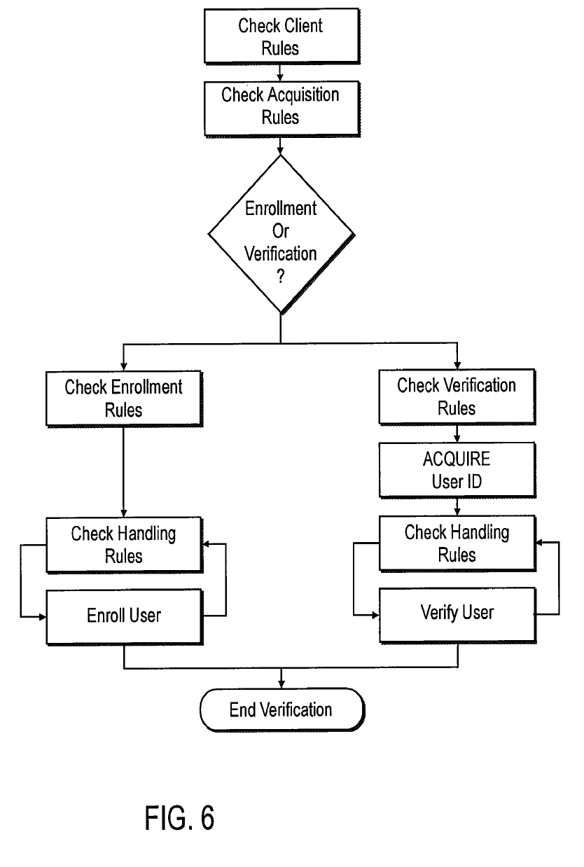

Using the logic as shown in FIG. 6, the GSRP executes in all cases using a generic security processing flow.

At many points in the logical flow, a Rule may request an interaction between the user and the authentication system 300 to acquire or confirm information. In these cases, the request type is applied against a XML Snippets database. These snippets contain the appropriate XML code (HTML, VoiceXML, etc) based on the requested Method.

Sample Use Case:

To illustrate this, a scenario for a telephone banking application will be described. In this example, a caller is attempting to access their bank account over the phone. The call will be received by an Interactive Voice Response application which will then transfer the call to the GSRP which will attempt to verify the caller's identity. The engine will ask the user for the caller's User ID and repeat a number of phrases before verifying the user.

Scenario 1: Voice Biometric Verification Via the Telephone.

Caller dials 800-nnn-nnnn. Call is received on a VoiceXML based IVR platform, which connects to a web server which contains a voice banking application. The caller is presented a menu, which says press-one for your balance. It is determined that a secure authentication is required, in this case a voice biometric engine.

The web server then submits the request to the GSRP passing the applicationID “banking-voice-auth”, a platform of “VoiceXML”, an Engine of “Voice1” to signify the first voice biometric engine, and that the Transaction Type is a “verification”.

The GSRP, receiving this information then starts applying the Client Rules based on the application ID:
GREETING RULE: Select the greeting message to play, in this case “Thank you for calling the bank”
Since this is a Verification process, next it goes to:
ACQUISITION RULE: Acquire-by UserID
Caller is requested to “Speak your user ID number”

The system then receives the user ID number and compares it against the Corporate User ID Data. The GSRP then grabs the appropriate template and prepares the Security Engine. The GSRP then compares the voiceprint of the user saying their ID number against the voiceprint stored in the Corporate User ID Data and scores the response.

The application ID then triggers the Verification rules based on the information that is in the Corporate User ID Data. In this case, the GSRP shows that the user has enrolled a specific passphrase and applies this rule:
VERIFICATION RULE: Verify Fixed Phrase
The caller is requested to “Please say ‘my voice is my passport’”

The GSRP passes this information over to the Security Engine which compares data against the Corporate User ID Data and scores the response.

The GSRP takes the scores from the User ID and the verification and determines if the condition is PASS, FAIL, or UNSURE. In this case, the system is UNSURE.

The GSRP checks the Corporate User ID Data and sees that the user has registered another phrase
VERIFICATION RULE: Verify Fixed Phrase
The caller is requested to “Please say ‘The Rain in Spain Falls Mainly on My Freshly Washed Car’”

The GSRP passes this information over to the Security Engine which compares data against the Corporate User ID Data and scores the response.

The GSRP takes the scores from the User ID and the verification of the two fixed phrases and determines if the condition is PASS, FAIL, or UNSURE. In this case, the system is PASS.

The GSRP submits (using PUT or GET) back to the original voice application on the web server that the condition is a PASS, and what the verified User ID is.

The originating voice application then regains control of the call to provide self service or transfer to an agent.

Sample Rules

Client Rules

These Rules are Taken Based on What Phone Number is Dialed

Greeting Rule
a. Plays a message, determines if a call is for a verification or an enrollment
b. Specifies if Acquisition or Enrollment uses names or ID numbers
c. Specifies maximum number of elements that can be used in a verification process

Engine Rule
a. Selects which core security engine to use for this transaction

Enrollment Rules

Confirm UserID
a. Uses a secondary information element to confirm ID to continue enrollment
b. Can be PIN number, passport, etc. . . . .

Enroll-by Rule
a. Inherits from the Client Rules if the client uses names or ID numbers
b. Prepares the enrollment

Enroll Secret
a. Enrolls an unguided phrase
b. For example: Please say your secret passphrase now
c. Applicable for behavioral biometric or security methods only

Enroll Shared Secret
a. Will provide a list of possible shared secret questions that an administrator can choose from when setting up an account/user
b. For example: favorite color, city of birth, etc. . . . .
c. Applicable for behavioral biometrics or security methods only

Enroll Fixed-Phrase
a. Administrator can pick a fixed phrase which all users will need to enroll
b. For example “Please say: Verify This Call”
c. This is applicable only for voice biometrics

Enroll Random-Three-Phrase
a. City
b. Color
c. Noun
d. Examples: Berlin Blue Giraffe, Chicago Orange Telephone
e. Administrator can use many random-three-phrase rules in an enrollment
f. This is applicable only for voice biometrics

Enroll Digits
a. Enroll the 10 digits
b. This is applicable only for voice biometrics

Enroll Physical Method
a. Enroll a physical biometric such as an iris scan, fingerprint
b. Enroll a smartcard

Enroll Password/PIN
a. Enroll a password or PIN based on administrator selected parameters
b. For physical biometric and security methods only

Acquire Rules

Acquire-By
a. Inherits method from Client Rules
b. Gets a user ID or user name
c. Pulls up the right record from the database
d. Performs a first verification

Verification Rules

Verify Secret

Verify Shared-Secret

### Verify Fixed Phrase

Verify Random-Three-Phrase
a. Selects one of n registered three-phrases

Verify Digits
b. Randomly generated
c. Minimum 4 digits, maximum 6 digits

Handling Rules

Verification Condition
a. Creates three branches: Pass, Fail, Get More Data
b. Get More Data means that the condition is questionable and, if possible based on the client rules, prompt for another verification to get a clear pass or fail condition

Time Since Enrollment
a. If enrollment has been within X months, create a logical branch in the callflow (for re-enrollment, or to pass to agent, etc)
b. For biometric methods only

Extend Call to Agent
a. Passing Data through to agent method specified by Administrator
b. Applicable for telephony transactions only

Extend Call to IVR
a. Pass data through to another automated voice system
b. Applicable for telephony transactions only

Extend to URI
a. Pass web transaction to a URI

Although illustrative embodiments of the present disclosure have been described in detail, it should be understood that various changes, substitutions and alternations can be made without departing from the spirit and scope of the disclosures as defined by the appended claims.

What is claimed is:

1. A method for authenticating and securing a communication between a user device and an application server, the method including:
receiving information related to a service request initiated by the user device, wherein the service request relates to access a service provided by an application of the application server;
determining a needed security level corresponding to the received service request based on authentication policy data, wherein the authentication policy data specifies a needed security level corresponding to each of a plurality of service requests for each of multiple applications;
determining whether a security level rating of an authentication method associated with the user device satisfies the needed security level corresponding to the received service request;
responsive to the security level rating of the authentication method associated with the user device failing to satisfy the needed security level corresponding to the service request, identifying an authentication process appropriate to the user device;
collecting authentication data from the user device according to the identified authentication process;
performing the identified authentication process; and
based on a result of the performed authentication process, selectively allowing the user device to access a service corresponding to the service request.

2. The method of claim 1, wherein a connection between the application server and the user device is opened if the result of the identified authentication process authenticates the user.

3. The method of claim 1 further comprising the step of responsive to the security level rating of the authentication method associated with the user device satisfying the needed security level corresponding to the service request, allowing the user device to access the service corresponding to the service request.

4. The method of claim 3, wherein the security level rating of the authentication method associated with the user device is determined to be satisfying the needed security level corresponding to the service request, if the security level rating of the authentication method is equal to or greater than the needed security level.

5. The method of claim 1, wherein the multiple applications reside on different servers.

6. The method of claim 1, wherein the authentication process appropriate to the user device is identified by performing the steps of:
accessing information related to one or more available authentication processes satisfying the needed security level; and
from the one or more available authentication processes satisfying the needed security level, selecting one of the one or more authentication process as the authentication process appropriate to the user device.

7. The method of claim 1, wherein different service requests have different needed security levels.

8. A data processing system for authenticating and securing a communication between a user device and an application server, the system comprising:
a data processor for processing data; and
a data storage device for storing instructions which, upon execution by the data processor, control the data processing system performs the steps of:
receiving information related to a service request initiated by the user device, wherein the service request relates to access a service provided by an application of the application server;
determining a needed security level corresponding to the received service request based on authentication policy data, wherein the authentication policy data specifies a needed security level corresponding to each of a plurality of service requests for each of multiple applications;
determining whether a security level rating of an authentication method associated with the user device satisfies the needed security level corresponding to the received service request;
responsive to the security level rating of the authentication method associated with the user device failing to satisfy the needed security level corresponding to the service request, identifying an authentication process appropriate to the user device;
collecting authentication data from the user device according to the identified authentication process;
performing the identified authentication process; and
based on a result of the performed authentication process, selectively allowing the user device to access a service corresponding to the service request.

9. The system of claim 8, wherein a connection between the application server and the user device is opened if the result of the identified authentication process authenticates the user.

10. The system of claim 8, wherein the instructions, upon execution by the data processor, further control the data processing system to perform the step of responsive to the security level rating of the authentication method associated with the user device satisfying the needed security level corresponding to the service request, allowing the user device to access the service corresponding to the service request.

11. The system of claim 10, wherein the security level rating of the authentication method associated with the user device satisfying the needed security level corresponding to the service request, if the security level rating of the authentication method is equal to or greater than the needed security level.

12. The system of claim 8, wherein the multiple applications reside on different servers.

13. The system of claim 8, wherein the authentication process appropriate to the user device is identified by performing the steps of:
accessing information related to one or more available authentication processes satisfying the needed security level; and
from the one or more available authentication processes satisfying the needed security level, selecting one of the one or more authentication process as the authentication process appropriate to the user device.

14. The system of claim 8 is implemented as a proxy server handling traffic for the application server.

15. The system of claim 8, wherein different service requests have different needed security levels.

16. A system for authenticating and securing a communication between a user device and an application server, the system comprising:
means for receiving information related to a service request initiated by the user device, wherein the service request relates to access a service provided by an application of the application server;
means for determining a needed security level corresponding to the received service request based on authentication policy data, wherein the authentication policy data specifies a needed security level corresponding to each of a plurality of service requests for each of multiple applications;
means for determining whether a security level rating of an authentication method associated with the user device satisfies the needed security level corresponding to the received service request;
means for identifying an authentication process appropriate to the user device, in response to the security level rating of the authentication method associated with the user device failing to satisfy the needed security level corresponding to the service request;
means for collecting authentication data from the user device according to the identified authentication process;
means for performing the identified authentication process; and
means for selectively allowing the user device to access a service corresponding to the service based on a result of the performed authentication process.
